(19) United States
(12) Patent Application Publication
(10) Pub. No.: US 2023/0006344 A1
(43) Pub. Date: Jan. 5, 2023

(54) ANTENNA PROTECTION STRUCTURE, AND ANTENNA MODULE, COMMUNICATION DEVICE, AND COMMUNICATION BASE STATION INCLUDING THE SAME, AND METHOD FOR MANUFACTURING ANTENNA PROTECTION STRUCTURE

(71) Applicant: Murata Manufacturing Co., Ltd., Nagaokakyo-shi (JP)

(72) Inventor: Tomoshige FURUHI, Nagaokakyo-shi (JP)

(73) Assignee: Murata Manufacturing Co., Ltd., Nagaokakyo-shi, Kyoto (JP)

(21) Appl. No.: 17/941,043

(22) Filed: Sep. 9, 2022

Related U.S. Application Data
(63) Continuation of application No. PCT/JP2021/000191, filed on Jan. 6, 2021.

(30) Foreign Application Priority Data
Mar. 12, 2020 (JP) 2020-042751

(51) Int. Cl. H01Q 1/42; H01Q 1/24

(52) U.S. Cl. CPC H01Q 1/422; H01Q 1/246; H01Q 9/0407

(57) ABSTRACT

A housing, which is an example of an antenna protection structure, includes a first dielectric layer, a second dielectric layer laminated on the first dielectric layer, and a third dielectric layer laminated on the second dielectric layer. The relative permittivity of the second dielectric layer is higher than the relative permittivity of the first dielectric layer and the relative permittivity of the second dielectric layer is higher than the relative permittivity of the third dielectric layer. Further, the thickness of the second dielectric layer is smaller than the thickness of the first dielectric layer in a lamination direction and the thickness of the second dielectric layer is smaller than the thickness of the third dielectric layer in the lamination direction.

### CROSS-REFERENCE TO RELATED APPLICATIONS

The present application is a continuation application of International Patent Application No. PCT/JP2021/000191, filed Jan. 6, 2021, which claims priority to Japanese Patent Application No. 2020-042751, filed Mar. 12, 2020, the entire contents of each of which being incorporated herein by reference.

### TECHNICAL FIELD

The present disclosure relates to an antenna protection structure and a method for manufacturing the same and, more particularly, to a technique for improving the radio wave transmission characteristics of the antenna protection structure.

### BACKGROUND ART

The antenna unit may be accommodated in a protection structure (radome) for protecting the antenna unit. The radome may be a dedicated member for protecting the antenna unit or may be a housing to accommodate the antenna unit together with another device.

U.S. Pat. No. 8,917,220 specification (Patent Document 1) discloses a sandwich type radome having a multilayer structure for an antenna that radiates radio waves in microwave bands and millimeter-wave bands. The radome in U.S. Pat. No. 8,917,220 specification (Patent Document 1) has a four-layer structure in which two matching layers are formed inside a structural layer and one matching layer is further formed outside the structural layer.

### CITATION LIST

Patent Document
Patent Document 1: U.S. Pat. No. 8,917,220 specification

### SUMMARY

### Technical Problems

An antenna unit may be used in a mobile device represented by a mobile phone or a smartphone. In the mobile device above, there is still a high demand for reduction in size, thickness, and weight. With this, the height of a protection structure (a housing, for example) for protecting an antenna unit is also preferably reduced. Further, the protection structure preferably has high transmittance in order to transmit a radio wave radiated from the antenna unit disposed therein with low loss.

It is basically premised that the radome disclosed in U.S. Pat. No. 8,917,220 specification (Patent Document 1) is installed on a large structure such as an aircraft. The total thickness of the radome in U.S. Pat. No. 8,917,220 specification (Patent Document 1) is approximately 10 to 16.5 mm, which can make it hard to apply the radome to the mobile device as described above.

The present disclosure has been made to solve the problem described above, as well as other issues, and one aspect thereof is to provide an antenna protection structure with increased transmittance while minimizing a total thickness.

### Solutions to Problems

An antenna protection structure according to an aspect of the present disclosure includes a first dielectric layer, a second dielectric layer disposed on the first dielectric layer, and a third dielectric layer disposed on the second dielectric layer. A elative permittivity of the second dielectric layer is higher than a relative permittivity of the first dielectric layer and the relative permittivity of the second dielectric layer is higher than a relative permittivity of the third dielectric layer. A thickness of the second dielectric layer is smaller than a thickness of the first dielectric layer in a lamination direction and the thickness of the second dielectric layer is smaller than a thickness of the third dielectric layer in the lamination direction.

### Advantageous Effects

An antenna protection structure according to an aspect of the present disclosure has a three-layer structure in which a second dielectric layer is sandwiched between a first dielectric layer and a third dielectric layer, and the inner second dielectric layer is made of a material with higher permittivity than other dielectric layers and is formed thinner than other dielectric layers. With the configuration above, high transmittance may be achieved while a thickness of the entire protection structure can be minimized.

### BRIEF DESCRIPTION OF DRAWINGS

FIG. 1 is an overall block diagram of a communication device to which a protection structure according to Embodiment 1 is applied.

FIG. 2 is a partial sectional view of the communication device in FIG. 1.

FIG. 3 is a diagram for explaining the transmittance of a dielectric having a three-layer structure.

FIG. 4 is a diagram for explaining display of a thickness of each dielectric layer using a triangular graph.

FIG. 5 is a diagram illustrating an example of a transmittance distribution when a total thickness is 2.0 mm in a protection structure for a single-band antenna.

FIG. 6 is a diagram illustrating the maximum value of the in-band minimum transmittance in FIG. 5.

FIG. 7 is a diagram for explaining bandpass characteristics of a protection structure optimally designed based on FIG. 6.

FIG. 8 is a diagram illustrating the maximum value of the in-band minimum transmittance when a total thickness is 1.5 mm in a protection structure for a dual-band antenna.

FIG. 9 is a diagram for explaining bandpass characteristics of a protection structure optimally designed based on FIG. 8.

FIG. 10 is a diagram illustrating the maximum value of the in-band minimum transmittance when the total thickness is 4.0 mm in the protection structure for the dual-band antenna.

FIG. 11 is a diagram for explaining bandpass characteristics of a protection structure optimally designed based on FIG. 10.

FIG. 12 is a diagram for explaining an example of a manufacturing process of an antenna protection structure.

FIG. 13 is a plan view of a lower mold in FIG. 12.

FIG. 14 is a partial sectional view of a communication device to which a protection structure according to Embodiment 2 is applied.

FIG. 15 is a sectional view of an antenna module to which a protection structure according to Embodiment 3 is applied.

FIG. 16 is a sectional view of an antenna module according to Modification 1.

FIG. 17 is a sectional view of an antenna module according to Modification 2.

### DESCRIPTION OF EMBODIMENTS

Hereinafter, embodiments of the present disclosure will be described in detail with reference to the drawings. Note that the same or corresponding portions in the drawings are denoted by the same reference signs, and the description thereof will not be repeated.

### Embodiment 1

(Basic Configuration of Communication Device)

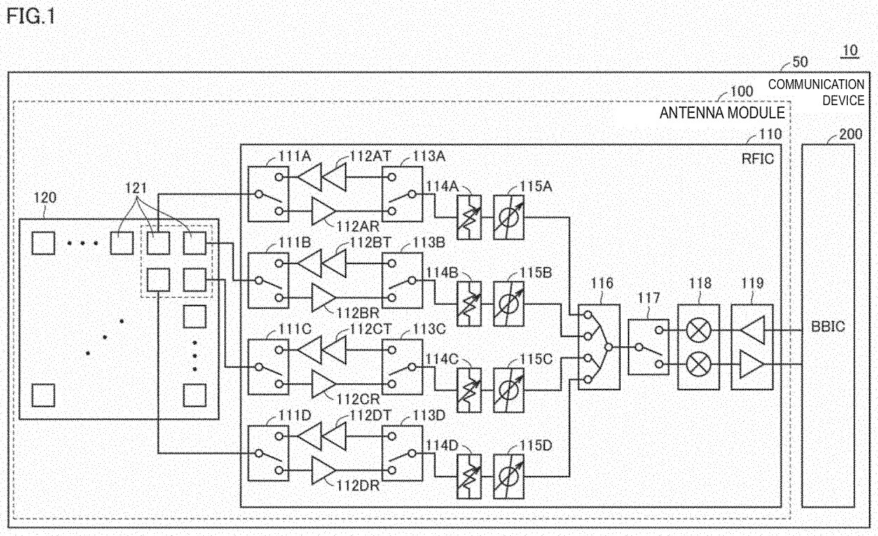

FIG. 1 is an example of a block diagram of a communication device 10 to which a protection structure 50 according to Embodiment 1 is applied. The communication device 10 is, for example, a mobile terminal such as a mobile phone, a smartphone, or a tablet; a personal computer having a communication function; or a communication base station. In the communication device 10, the protection structure 50 is a housing of the communication device 10. Hereinafter, in Embodiment 1, a protection structure may simply be referred to as a “housing”.

The protection structure 50 according to Embodiment 1 accommodates an antenna module 100. In the example of Embodiment 1, an example of a frequency band of a radio wave used in the antenna module 100 is a radio wave in a millimeter-wave band having a center frequency of 28 GHz, 39 GHz, 60 GHz, or the like, for example. However, a radio wave in frequency bands other than the above may be used.

According to FIG. 1, the communication device 10 includes the antenna module 100 and a baseband integrated circuit (BBIC) 200 that constitutes a baseband signal processing circuit. The antenna module 100 and the BBIC 200 are accommodated in the protection structure 50 (housing). The antenna module 100 includes a radio-frequency (RF) integrated circuit (RFIC) 110, which is an example of a power feed circuit, and an antenna unit 120. The communication device 10 up-converts a signal transferred from the BBIC 200 to the antenna module 100 into a radio frequency signal and radiates the signal from the antenna unit 120. The communication device 10 down-converts a radio frequency signal received by the antenna unit 120 and processes the signal in the BBIC 200.

Note that, although the RFIC 110 is included in the antenna module 100 in the example of FIG. 1, it is sufficient that the antenna module 100 includes at least the antenna unit 120, and the RFIC 110 may be formed outside of the antenna module 100 as same as the BBIC 200.

In FIG. 1, for ease of description, among a plurality of feed elements 121 constituting the antenna unit 120, only a configuration corresponding to four feed elements 121 is illustrated, and configurations corresponding to other feed elements 121 that have the same configuration are omitted. The term “feed element” is intended as a transmit and/or receive device that, in a transmit context, is actively fed with RF energy which is then launched by a radiation element (e.g., patch antenna) into a wireless propagation medium as electromagnetic waves, and in a receive context operates in a reciprocal process by converting electromagnetic waves from a wireless medium into electrical energy (current and/or field) in a tangible medium. Note that, although FIG. 1 illustrates an example in which the antenna unit 120 is formed by the plurality of feed elements 121 disposed in a two-dimensional array, the number of feed elements 121 is not necessarily plural, and the antenna unit 120 may be formed by one feed element 121. Further, a one-dimensional array in which the plurality of feed elements 121 are disposed in a line may be used. In the present embodiment, the feed element 121 is a patch antenna having a substantially square flat plate shape.

The RFIC 110 includes switches 111A to 111D, 113A to 113D, and 117, power amplifiers 112AT to 112DT, low-noise amplifiers 112AR to 112DR, attenuators 114A to 114D, phase shifters 115A to 115D, a multiplexer/demultiplexer 116, a mixer 118, and an amplifier 119.

When a radio frequency signal is transmitted, the switches 111A to 111D and 113A to 113D are switched to the sides of power amplifiers 112AT to 112DT, and the switch 117 is connected to the transmission-side amplifier in the amplifier 119. When a radio frequency signal is received, the switches 111A to 111D and 113A to 113D are switched to the sides of the low-noise amplifiers 112AR to 112DR, and the switch 117 is connected to the reception-side amplifier in the amplifier 119.

A signal transferred from the BBIC 200 is amplified by the amplifier 119 and is up-converted by the mixer 118. A transmission signal, which is an up-converted radio frequency signal, is divided into four waves by the multiplexer/demultiplexer 116. The waves pass through four signal paths and are fed to the feed elements 121 different from one another. At this time, the directivity of the antenna unit 120 may be adjusted by individually adjusting the phase shift in the phase shifters 115A to 115D disposed in the respective signal paths.

Reception signals, which are the radio frequency signals received by the feed elements 121, respectively go through four different signal paths and are combined by the multiplexer/demultiplexer 116. The combined reception signal is down-converted by the mixer 118, amplified by the amplifier 119, and transferred to the BBIC 200.

The RFIC 110 is formed as, for example, a single chip integrated circuit component including the circuit configuration described above. Alternatively, devices (switch, power amplifier, low-noise amplifier, attenuator, and phase shifter) supporting each feed element 121 in the RFIC 110 may be formed as a single chip integrated circuit component for each corresponding feed element 121.

(Configuration of Housing and Antenna Module)

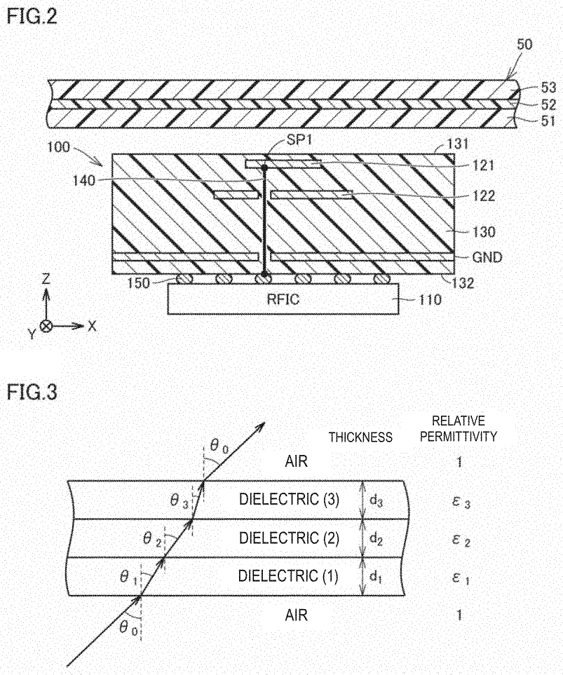

FIG. 2 is a partial sectional view of a portion of the communication device 10 in FIG. 1 including the protection structure 50 and the antenna module 100.

According to FIG. 2, the antenna module 100 includes a parasitic element 122, a dielectric substrate 130, a feed line 140, and a ground electrode GND in addition to the feed element 121 and the RFIC 110. Note that, in the following description, the positive direction of the Z-axis may be referred to as an upper surface side, and the negative direction may be referred to as a lower surface side.

Examples of the dielectric substrate 130 include: a low temperature co-fired ceramics (LTCC) multilayer substrate, a multilayer resin substrate formed by laminating a plurality of resin layers made of a resin such as epoxy or polyimide, a multilayer resin substrate formed by laminating a plurality of resin layers made of a liquid crystal polymer (LCP) with further lower permittivity, a multilayer resin substrate formed by laminating a plurality of resin layers made of a fluorine-based resin, and a ceramics multilayer substrate other than LTCC. Note that the dielectric substrate 130 does not necessarily have a multilayer structure and may have a single-layer substrate.

The dielectric substrate 130 has a substantially rectangular shape in plan view from a normal direction (Z-axis direction), and the feed element 121 is disposed on a side of an upper surface 131 (surface in the positive direction of the Z-axis) of the dielectric substrate 130 to face the ground electrode GND. The feed element 121 may be exposed on a surface of the dielectric substrate 130 or may be disposed in an inner layer of the dielectric substrate 130 as in the example of FIG. 2.

The parasitic element 122 is disposed to face the ground electrode GND in a layer closer than the feed element 121 to a side of the ground electrode GND. In other words, the parasitic element 122 is disposed in a layer between the feed element 121 and the ground electrode GND. The parasitic element 122 overlaps the feed element 121 in plan view of the dielectric substrate 130. A size of the feed element 121 is smaller than a size of the parasitic element 122, and a resonant frequency of the feed element 121 is higher than a resonant frequency of the parasitic element 122. That is, a frequency of a radio wave radiated from the feed element 121 is higher than a frequency of a radio wave radiated from the parasitic element 122. For example, a center frequency of the radio wave radiated from the feed element 121 is 39 GHz, and a center frequency of the radio wave radiated from the parasitic element 122 is 28 GHz.

A radio frequency signal is transferred to the feed element 121 from the RFIC 110 via the feed line 140. The feed line 140 starts from the RFIC 110, penetrates through the ground electrode GND and the parasitic element 122, and is connected to a feed point SP1 from the lower surface side of the feed element 121. That is, the feed line 140 transfers a radio frequency signal to the feed point SP1 of the feed element 121.

The feed point SP1 is disposed at a position offset from a center of the feed element 121 in a negative direction of the X-axis. When a radio frequency signal corresponding to the resonant frequency of the feed element 121 is supplied to the feed line 140, a radio wave having a polarization direction in the X-axis direction is radiated from the feed element 121. Further, when a radio frequency signal corresponding to the resonant frequency of the parasitic element 122 is supplied to the feed line 140, the feed line 140 and the parasitic element 122 are electromagnetically coupled to each other at the penetration position of the parasitic element 122, and the parasitic element 122 is excited. Thus, a radio wave having a polarization direction in the X-axis direction is radiated from the parasitic element 122.

That is, the antenna module 100 is a so-called dual-band antenna module capable of radiating radio waves in two different frequency bands.

The housing, which is an example of the protection structure 50, has a structure in which three dielectric layers are laminated or disposed. Specifically, a dielectric layer 52 is laminated or disposed on a dielectric layer 51, and a dielectric layer 53 is further laminated or disposed on the dielectric layer 52. A thickness (d₂) of the dielectric layer 52 is smaller than a thickness (d₁) of the dielectric layer 51 and a thickness (d₃) of the dielectric layer 53 (that is, d₂<d₁ and d₂<d₃). Further, relative permittivity (ε₂) of the dielectric layer 52 is higher than relative permittivity (ε₁) of the dielectric layer 51 and relative permittivity (ε₃) of the dielectric layer 53 (that is, ε₂>ε₁ and ε₂>ε₃).

Note that, in the example of FIG. 2, a case will be described in which the dielectric layer 51 and the dielectric layer 53 have the same thickness (d₁=d₃) and the same relative permittivity (ε₁=ε₃), but the thicknesses and relative permittivity of the dielectric layer 51 and the dielectric layer 53 need not necessarily be the same.

(Description of Transmittance of Housing Having Three-Layer Structure)

Next, a method of determining the permittivity of a dielectric having a three-layer structure will be described with reference to FIG. 3. FIG. 3 illustrates a model in a case that a planar electromagnetic wave is incident on a dielectric having a three-layer structure disposed in air. The model in FIG. 3 corresponds to the protection structure 50 illustrated in FIG. 2, and a dielectric (1) in FIG. 3 corresponds to the dielectric layer 51 of the protection structure 50 in FIG. 2. Similarly, a dielectric (2) and a dielectric (3) in FIG. 3 correspond to the dielectric layer 52 and the dielectric layer 53 in FIG. 2, respectively. Note that the thicknesses of the dielectrics (1), (2), and (3) are denoted as d₁, d₂, and d₃, respectively, and the relative permittivity thereof is denoted as ε₁, ε₂, and ε₃, respectively.

As illustrated in FIG. 3, it is assumed that an electromagnetic wave enters the dielectric (1) from the air at an angle of θ₀. When refraction angles in the respective dielectrics are θ₁, θ₂, and θ₃, following Equation (1) holds from Snell's law.

[Formula 1]

sin θ₀=ε₁ sin θ₁=ε₂ sin θ₂=ε₃ sin θ₃. (1)

Accordingly, the refraction angle θₖ in the dielectric (k) may be expressed as Equation (2).

$$[ Formula 2 ]$$

$${θ}_{k} = Arcsin ( \frac{sin {θ}_{0}}{\sqrt{{ε}_{k}}} ) \qquad ( 2 )$$

That is, the refractive index within each dielectric is independent from the permittivity of other dielectrics. Further, the angle of emission from the dielectric (3) is equal to the angle of incidence from the air to the dielectric (1).

When transmission and reflection in a multilayer dielectric film are determined, a characteristics matrix method is used in many cases (a document “Design of Thin-Film Optical Filters”, Kobiyama Mitsunobu, Optronics Co., LTD., 2006, for example). In the characteristics matrix method, a characteristics matrix Mₖ of a dielectric (k) is defined as following Equation (3).

$$[ Formula 3 ]$$

$${M}_{k} = [ \begin{matrix}cos {δ}_{k} & ( j sin {δ}_{k} ) / {η}_{k} \\ j {η}_{k} sin {δ}_{k} & cos {δ}_{k}\end{matrix} ] \qquad ( 3 )$$

Here, δₖ represents a phase shift amount in the dielectric (k) and is defined by following Equation (4).

$$[ Formula 4 ]$$

$${δ}_{k} = \frac{2 π}{{λ}_{0}} \sqrt{{ε}_{k}} {d}_{k} cos {θ}_{k} \qquad ( 4 )$$

Further, ηₖ is referred to as gradient admittance and is defined as in Equation (5). Note that ηₖ* in an upper part of Equation (5) is gradient admittance when an electric field of an incident wave is perpendicular to an incident surface (that is, paper surface), and ηₖ^{p} in the lower part of Equation (5) is gradient admittance when an electric field of an incident wave is parallel to an incident surface. In a case of an air layer (k=0, ε₀=1), it is defined as Equation (6).

$$[ Formula 5 ]$$

$${η}_{k} = \{ \begin{matrix}{η}_{k}^{s} = \sqrt{{ε}_{k}} cos {θ}_{k} \\ {η}_{k}^{P} = \sqrt{{ε}_{k}} / cos {θ}_{k}\end{matrix} \qquad ( 5 )$$

$${η}_{0} = \{ \begin{matrix}{η}_{0}^{s} = cos {θ}_{0} \\ {η}_{0}^{P} = 1 / cos {θ}_{0}\end{matrix} \qquad ( 6 )$$

The matrix product P for three layers of the characteristics matrix defined as above is defined as following Equation (7).

$$[ Formula 6 ]$$

$$P = [ \begin{matrix}cos {δ}_{1} & ( j sin {δ}_{1} ) / \sqrt{{ε}_{1}} \\ j \sqrt{{ε}_{1}} sin {δ}_{1} & cos {δ}_{1}\end{matrix} ] [ \begin{matrix}cos {δ}_{2} & ( j sin {δ}_{2} ) / \sqrt{{ε}_{2}} \\ j \sqrt{{ε}_{2}} sin {δ}_{2} & cos {δ}_{2}\end{matrix} ] \\ [ \begin{matrix}cos {δ}_{3} & ( j sin {δ}_{3} ) / \sqrt{{ε}_{3}} \\ j \sqrt{{ε}_{3}} sin {δ}_{3} & cos {δ}_{3}\end{matrix} ] \qquad ( 7 )$$

Here, when each component of the matrix product P is defined as in Equation (8), a transmittance T and a phase φₜ of the power of an electromagnetic wave may be expressed as in following Equation (9) and Equation (10).

$$[ Formula 7 ]$$

$$P = [ \begin{matrix}{p}_{11} & {jp}_{12} \\ {jp}_{21} & {p}_{22}\end{matrix} ] \qquad ( 8 )$$

$$T = \frac{4 {η}_{0}^{2}}{{{η}_{0}^{2} ( {p}_{11} + {p}_{22} )}^{2} + {( {η}_{0}^{2} {p}_{12} + {p}_{21} )}^{2}} \qquad ( 9 )$$

$${ϕ}_{t} = Arctan \frac{- ( {η}_{0}^{2} {p}_{12} + {p}_{21} )}{{η}_{0} ( {p}_{11} + {p}_{22} )} \qquad ( 10 )$$

Note that, when variables are defined as in Equation (11), each component of the matrix product P of Equation (8) may be expressed as in Equation (12).

$$[ Formula 8 ]$$

$${s}_{k} = sin {δ}_{k} \\ {c}_{k} = cos {δ}_{k} \\ {n}_{k} = \sqrt{{ε}_{k}} \qquad ( 11 )$$

$$\{ \begin{matrix}{p}_{11} = {c}_{1} {c}_{2} {c}_{3} - \frac{{n}_{2} {s}_{1} {s}_{2} {c}_{3}}{{n}_{1}} - \frac{{n}_{3} {c}_{1} {s}_{2} {s}_{3}}{{n}_{2}} - \frac{{n}_{3} {s}_{1} {c}_{2} {s}_{3}}{{n}_{1}} \\ {p}_{12} = \frac{{s}_{1} {c}_{2} {c}_{3}}{{n}_{1}} + \frac{{c}_{1} {s}_{2} {c}_{3}}{{n}_{2}} + \frac{{c}_{1} {c}_{2} {s}_{3}}{{n}_{3}} - \frac{{n}_{2} {s}_{1} {s}_{2} {s}_{3}}{{n}_{1} {n}_{3}} \\ {p}_{21} = {n}_{1} {s}_{1} {c}_{2} {c}_{3} + {n}_{2} {c}_{1} {s}_{2} {c}_{3} + {n}_{3} {c}_{1} {c}_{2} {s}_{3} - \frac{{n}_{1} {n}_{3} {s}_{1} {s}_{2} {s}_{3}}{{n}_{2}} \\ {p}_{22} = {c}_{1} {c}_{2} {c}_{3} - \frac{{n}_{1} {s}_{1} {s}_{2} {c}_{3}}{{n}_{2}} - \frac{{n}_{2} {c}_{1} {s}_{2} {s}_{3}}{{n}_{3}} - \frac{{n}_{1} {s}_{1} {c}_{2} {s}_{3}}{{n}_{3}}\end{matrix} \qquad ( 12 )$$

When an electromagnetic wave is perpendicularly incident on a dielectric from a front direction (that is, incident angle θᵢ=0), amplitude reflectance ρ may be expressed as in following Equation (13).

$$[ Formula 9 ]$$

$$ρ = \frac{{p}_{11} - {p}_{22} + j ( {p}_{12} - {p}_{21} )}{{p}_{11} + {p}_{22} + j ( {p}_{12} + {p}_{21} )} \qquad ( 13 )$$

In a case of the perpendicular incidence, the transmittance T in Equation (9) is expressed as Equation (14) using the amplitude reflectance ρ.

T=|p|² (14)

Here, in a case that the transmittance T is 1, that is, in order to satisfy ρ=0, it is necessary that the numerator of Equation (13) is 0, and thus following Equation (15) holds.

$$[ Formula 10 ]$$

$$\{ \begin{matrix}{p}_{11} - {p}_{22} = 0 \\ {p}_{12} - {p}_{21} = 0\end{matrix} \qquad ( 15 )$$

That is, when following Equation (16) is satisfied, the transmittance becomes 1.

$$[ Formula 11 ]$$

$$\{ \begin{matrix}( \frac{{n}_{2}}{{n}_{1}} - \frac{{n}_{1}}{{n}_{2}} ) {s}_{1} {s}_{2} {c}_{3} + ( \frac{{n}_{3}}{{n}_{2}} - \frac{{n}_{2}}{{n}_{3}} ) {c}_{1} {s}_{2} {s}_{3} - ( \frac{{n}_{1}}{{n}_{3}} - \frac{{n}_{3}}{{n}_{1}} ) {s}_{1} {c}_{2} {s}_{3} = 0 \\ \begin{matrix}( {n}_{1} - \frac{1}{{n}_{1}} ) {s}_{1} {c}_{2} {c}_{3} + ( {n}_{2} - \frac{1}{{n}_{2}} ) {c}_{1} {s}_{2} {c}_{3} + ( {n}_{3} - \frac{1}{{n}_{3}} ) {c}_{1} {c}_{2} {s}_{3} + \\ ( \frac{{n}_{2}}{{n}_{1} {n}_{3}} - \frac{{n}_{1} {n}_{3}}{{n}_{2}} ) {s}_{1} {s}_{2} {s}_{3} = 0\end{matrix}\end{matrix} \qquad ( 16 )$$

Since there are six independent variables d₁, d₂, d₃, ε₁, ε₂, and ε₃ in the three-layer dielectric structure, four-dimensional degrees of freedom remain under the condition of two equations in Equation (16). That is, when four of the six variables are designated, the remaining two variables are determined. However, in an actual design, since a usable range (restriction condition) is given to each variable, there may be a case that a solution satisfying Equation (16) does not exist depending on the restriction condition. Further, since a periodic function is included in Equation (16), when a solution exists, an infinite number of discrete solutions may exist in many cases.

In a situation that an actual product is designed, there may be often cases that it is unable to set the transmittance to 1 over an entire predetermined frequency band, depending on a required specification (restriction condition). That is, in practice, it is required to maximize a specific characteristics index (such as angle characteristics and frequency characteristics of transmittance, for example) in a given specification.

In the present embodiment, a condition is examined in which the transmittance in a target frequency band is maximized within an achievable range of the relative permittivity, while the total thickness is constrained which is often restricted by characteristics such as strength, weight, and design in many cases.

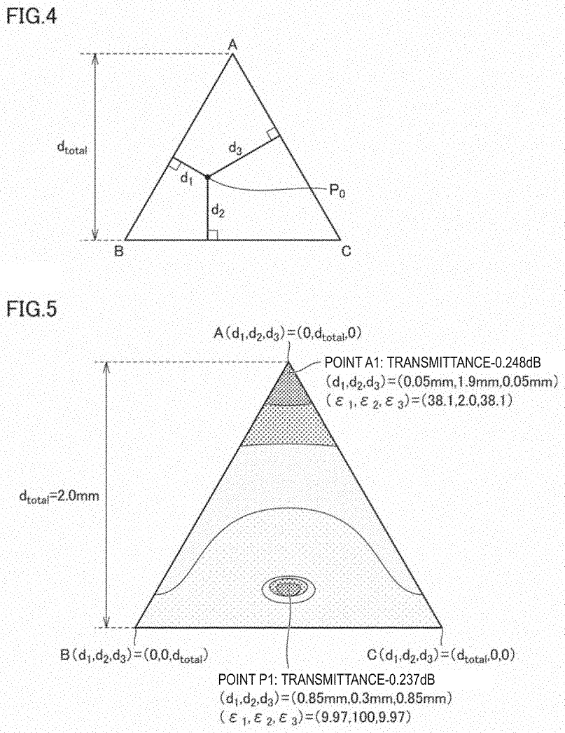

FIG. 4 is a diagram for explaining display of the thickness of each dielectric layer using a triangular graph. In the triangular graph in FIG. 4, a distance (height) from each side to a corresponding vertex is set to a total thickness dₜₒₜₐₗ of a dielectric. The lengths of perpendicular lines from an any point P0 in an equilateral triangle ABC to the respective sides are the thicknesses of the respective dielectrics. Specifically, the length of the perpendicular line from the point P0 to a side AB is the thickness d₁ of the dielectric (1), the length of the perpendicular line from the point P0 to a side BC is the thickness d₂ of the dielectric (2), and the length of the perpendicular line from the point P0 to a side CA is the thickness d₃ of the dielectric (3). At this time, the relationship in the following Equation (17) holds.

dₜₒₜₐₗ=d₁+d₂+d₃ (17)

Accordingly, each vertex of the triangle corresponds to a case that one dielectric occupies all the thickness. Further, each side corresponds to a case that the thickness of one dielectric is 0. For example, in a case of the vertex A, a protection structure is formed only by the dielectric (2), and in a case of being on the side AB, a protection structure is formed by the dielectric (2) and the dielectric (3).

### First Configuration Example

FIG. 5 is a diagram illustrating an example of a simulation of a transmittance distribution when the total thickness is 2.0 mm (dₜₒₜₐₗ=2.0) in a single-band protection structure. The simulation of FIG. 5 illustrates a distribution of a minimum value of transmittance in the front direction at each point inside the triangular graph, when the relative permittivity of each dielectric is varied from 2 to 100 (2≤εₖ≤100). Note that the frequency band of the target radio wave is BW1: 24.25 to 29.5 GHz (center frequency: 26.875 GHz). FIG. 5 is illustrated such that the denser the hatching is, the higher the transmittance is.

In FIG. 5, a portion where the transmittance is high (that is, a portion where hatching is dense) is a portion of a point A1 near the vertex A and a portion of a point P1 near the center of gravity of the triangle.

At the point A1 close to the vertex A having the maximum transmittance, (d₁, d₂, d₃)=(0.05 mm, 1.9 mm, 0.05 mm), and the transmittance is −0.248 dB. Further, the relative permittivity at that case is expressed as (ε₁, ε₂, ε₃)=(38.1, 2.0, 38.1). Further, at the point P1, (d₁, d₂, d₃)=(0.85 mm, 0.3 mm, 0.85 mm), and the transmittance is −0.237 dB. The relative permittivity at that case is expressed as (ϵ₁, ε₂, ε₃)=(9.97, 100, 9.97).

Note that, in both cases of the point A1 and the point P1, the maximum transmittance is achieved when the thicknesses and relative permittivity of the dielectric layers (1) and (3) on outer sides are equal to each other. Not limited to this example, when the combination of the thicknesses of the three layers is varied, the maximum transmittance is achieved when the dielectric layers (1) and (3) on the outer sides are equal to each other. When a configuration with the maximum transmittance is determined, therefore, it is sufficient to search under the condition that the dielectric layers (1) and (2) on the outer sides are equal to each other. This condition corresponds to a condition being on a perpendicular line extending from the vertex A to the side BC in FIG. 4 or FIG. 5. Conditions under which the maximum transmittance is achieved within the condition range above will be examined below.

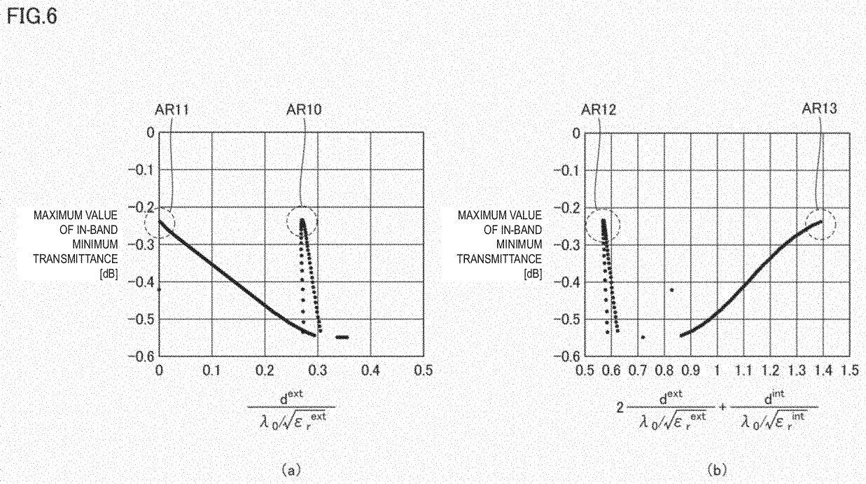

FIG. 6 is a diagram illustrating the maximum value of the in-band minimum transmittance under the condition that the dielectric layers (1) and (3) on the outer sides are equal to each other in the configuration example of FIG. 5. Note that, in the present disclosure, the “in-band minimum transmittance” refers to the minimum value of transmittance within a predetermined frequency band (24.25 to 29.5 GHz, for example). In FIG. 6, the horizontal axis is a value obtained by dividing a thickness of a dielectric layer in a case of the center frequency by an effective wavelength in the dielectric layer. The value is used as a parameter, and the maximum value of the in-band minimum transmittance with respect to the parameter is plotted. Note that the “effective wavelength in the dielectric layer” is a wavelength obtained by dividing a wavelength in a free space by a square root of the relative permittivity of the dielectric layer.

In FIG. 6, in the left diagram (FIG. 6(a)), the horizontal axis illustrates the parameter of the outer dielectric layer (1) or dielectric layer (3), and in the right diagram (FIG. 6(b)), the horizontal axis illustrates the sum of the parameters of each of the three layers. Note that, in FIG. 6(b), the dielectric layers (1) and (3) on the outer sides have the same thickness and relative permittivity.

In the parameters of FIG. 6, d^{ext} and εᵣ^{ext} represent the thickness and relative permittivity of the outer dielectric layers (1) and (3), respectively. Further, d^{int} and εᵣ^{int} represent the thickness and relative permittivity of the inner dielectric layer (2), respectively. λ₀ represents the wavelength of a radio wave in the air at a center frequency. The parameter described above is, in a physical aspect, an index indicating the wave number of a radio wave transmitted through the dielectric. Note that, the parameter described above corresponds to a “first parameter” in the present disclosure.

In FIG. 6(a), a region AR10 indicates the point P1 in FIG. 5, and a region AR11 indicates the point A in FIG. 5. In FIG. 6(b), a region AR12 indicates the point P1 in FIG. 5, and a region AR13 indicates the point A in FIG. 5. As can be seen in FIG. 5 and FIG. 6, at the point A in FIG. 5, it is necessary to make the outer dielectric layers (1) and (3) high in permittivity and small in thickness. However, it is hard to realize dielectric layers having the configuration described above in an actual manufacturing stage. Under the conditions described above, therefore, the configuration of the point P1 is optimally designed. Here, the configuration of the point P1 is the configuration in which the relative permittivity of the dielectric layer (2) is higher than the relative permittivity of the dielectric layers (1) and (3), and the thickness of the dielectric layer (2) is smaller than the thicknesses of the dielectric layers (1) and (3). Note that, at this time, as illustrated in FIG. 6, the parameter of each outer dielectric layer is in a range of 0.26 to 0.27, and the parameter of all the three layers is in a range of 0.55 to 0.57.

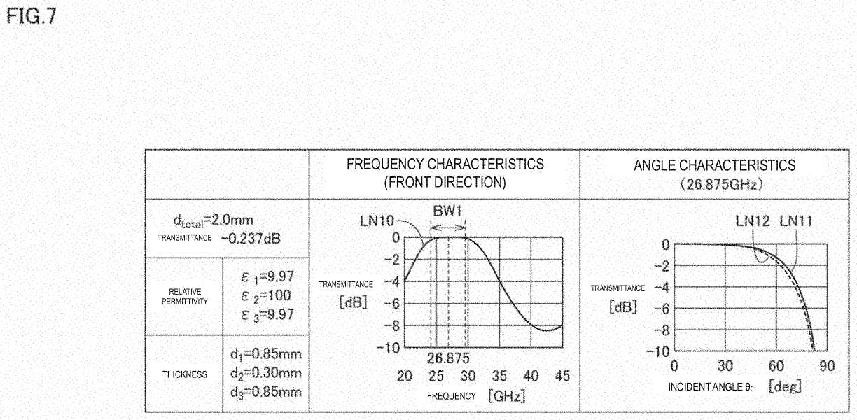

FIG. 7 is a diagram for explaining the bandpass characteristics of a protection structure optimally designed based on FIG. 6. In FIG. 7, illustrated are frequency characteristics of transmittance in the front direction and angle characteristics (transmittance with respect to incident angle) at a center frequency. Note that, in the angle characteristics, a solid line LN11 indicates a case that an electric field of an incident wave is perpendicular to an incident surface, and a broken line LN12 indicates a case that an electric field of an incident wave is parallel to an incident surface. As illustrated in the frequency characteristics (solid line LN10) in FIG. 7, a substantially flat transmittance is achieved in the target frequency band BW1. Further, in both cases that the electric field of the incident wave is perpendicular and the electric field of the incident wave is parallel, the transmittance of −1.5 dB or more is achieved until the incident angle θ₀ is approximately 60°.

As described above, a single-band antenna protection structure formed of three dielectric layers may achieve high transmittance while minimizing a thickness of the entire protection structure with the configuration as follows. The relative permittivity of an inner dielectric layer is made higher than the relative permittivity of the outer dielectric layers, the thickness of the inner dielectric layer is made smaller than the thicknesses of the dielectrics of the outer dielectric layers, and the parameters indicated in FIG. 6 are set within predetermined ranges.

### Second Configuration Example

In the first configuration example described above, a method for optimally setting a protection structure for a single-band antenna has been described. In a second configuration example and a third configuration example to be described next, examples will be described in which the protection structure of a dual-band antenna is optimally designed by the same method as described above.

As described above, the condition under which the transmittance in the front direction is 1 at a specific single frequency is Equation (16) described above. Here, as illustrated in FIG. 5, under the restriction of the total thickness of the dielectrics, the condition for achieving the high transmittance over a wide band is the case that the thicknesses and relative permittivity of the outer dielectric layers (1) and (3) are equal (d₁=d₃, ε₁=ε₃). Thus, the first equation of Equation (16) identically holds, and the second equation is reduced to following Equation (18).

$$[ Formula 12 ]$$

$$2 ( {n}_{1} - \frac{1}{{n}_{1}} ) {s}_{1} {c}_{1} {c}_{2} + ( {n}_{2} - \frac{1}{{n}_{2}} ) {c}_{1}^{2} {s}_{2} + ( \frac{{n}_{2}}{{n}_{1}^{2}} - \frac{{n}_{1}^{2}}{{n}_{2}} ) {s}_{1}^{2} {s}_{2} = 0 \qquad ( 18 )$$

In a case of a dual-band antenna, the relationship in Equation (18) holds for two different frequencies. Here, from the relationship of d₁=d₃ and ε₁=ε₃, the variables to be determined are four variables of d₁, d₂, ε₁, and ε₂. Since the Equation (18) holds for two frequencies, the degree of freedom is 2 as a result. Accordingly, when two of the variables d₁, d₂, ε₁, and ε₂ are given, the remaining two variables are determined.

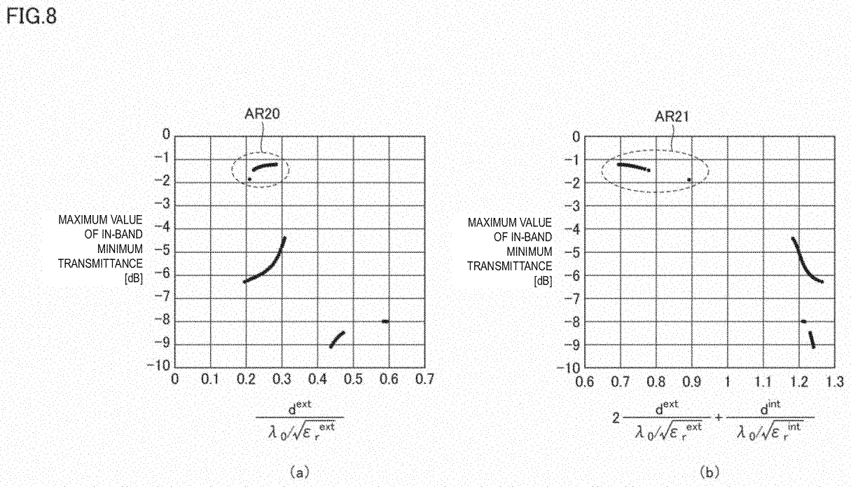

FIG. 8 is a diagram illustrating the maximum value of the in-band minimum transmittance when a total thickness is 1.5 mm in a protection structure for a dual-band antenna. Note that, in the example of FIG. 8, the target frequency bands are BW1: 24.25 to 29.5 GHz (center frequency: 26.875 GHz) and BW2: 37.0 to 40.0 GHz (center frequency: 38.5 GHz).

According to FIG. 8, the outer dielectric layer exhibits the transmittance below. The maximum value of the in-band minimum transmittance is a relatively large value of −2 dB or more in a region AR20 in FIG. 8(a). In the three layers in total, the maximum value of the in-band minimum transmittance is a value of −2 dB or more in a region AR21 in FIG. 8(b). These regions correspond to the point P1 in the triangular graph of FIG. 5. That is, when the parameter of the outer dielectric layer is in a range of 0.21 to 0.28 and the above-described parameter of the three layers in total is in a range of 0.69 to 0.89, the transmittance in two target frequency bands may be made maximum.

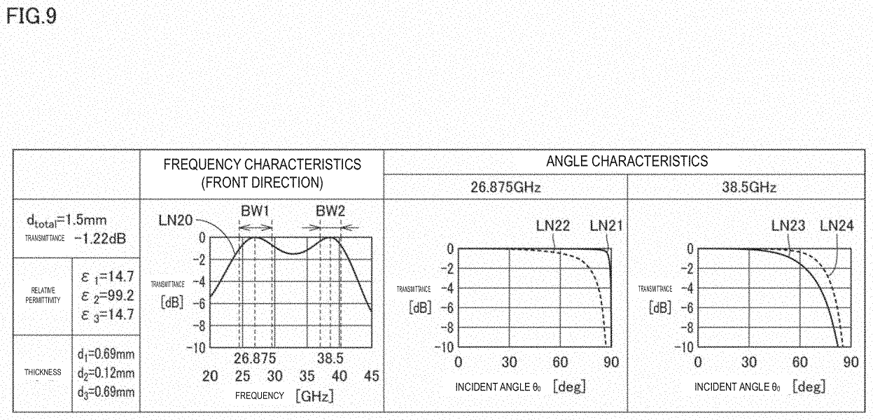

FIG. 9 is a diagram illustrating the bandpass characteristics of a protection structure optimally designed based on the simulation result in FIG. 8. FIG. 9 illustrates the frequency characteristics of the transmittance when the maximum values of the in-band minimum transmittance become the largest in the two frequency bands, and the angle characteristics at the center frequencies (26.875 GHz and 38.5 GHz) of the two bands. In the example illustrated in FIG. 9, the thicknesses of the respective dielectric layers are expressed as (d₁, d₂, d₃)=(0.69 mm, 0.12 mm, 0.69 mm), and the relative permittivity thereof are expressed as (ε₁, ε₂, ε₃)=(14.7, 99.2, 14.7). That is, the relative permittivity of an inner dielectric layer is higher than the relative permittivity of outer dielectric layers, and the thickness of the inner dielectric layer is smaller than the thicknesses of the outer dielectric layers.

According to FIG. 9, as for the frequency characteristics (solid line LN20), the transmittance is 1 (that is, 0 dB) at each of the center frequencies, and −1.22 dB is achieved as the minimum transmittance in the predetermined frequency band. Further, with respect to the angle characteristics, in both cases that an electric field of an incident wave is perpendicular (solid lines LN21 and LN23) and an electric field of an incident wave is horizontal (broken lines LN22 and LN24), the transmittance of −1.5 dB or more is achieved up to a range that the incident angle θ₀ is 60° or more.

As described above, a dual-band antenna protection structure formed of three dielectric layers may also achieve high transmittance while minimizing a thickness of the entire protection structure with the configuration as follows. The relative permittivity of an inner dielectric layer is made higher than the relative permittivity of outer dielectric layers, the thickness of the inner dielectric layer is made smaller than the thicknesses of the outer dielectric layers, and the parameters are set within the predetermined ranges indicated in FIG. 8.

### Third Configuration Example

In a third configuration example, an example is described in which a total thickness is set to 4.0 mm in a protection structure for a dual-band antenna.

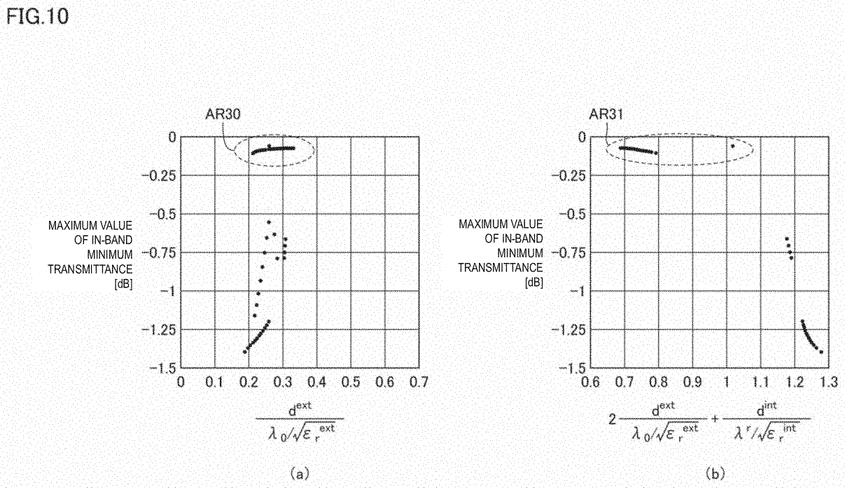

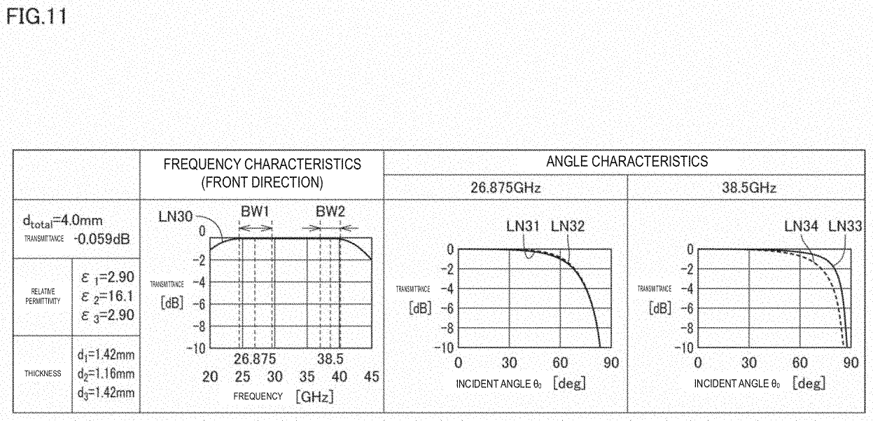

FIG. 10 is a diagram illustrating the maximum value of the in-band minimum transmittance in the third configuration example. Further, FIG. 11 is a diagram illustrating the bandpass characteristics of a protection structure optimally designed based on the simulation result in FIG. 10. Note that, also in the third configuration example, target frequency bands are BW1: 24.25 to 29.5 GHz (center frequency: 26.875 GHz) and BW2: 37.0 to 40.0 GHz (center frequency: 38.5 GHz).

According to FIG. 10, the outer dielectric layer exhibits the transmittance below. The maximum value of the in-band minimum transmittance is a relatively large value of −0.25 dB or more in a region AR30 in FIG. 10(a). In the three layers in total, the maximum value of the in-band minimum transmittance is −0.25 dB or more in a region AR31 in FIG. 10(b). That is, when the parameter of the outer dielectric layer is in a range of 0.21 to 0.33 and the above-described parameter of the three layers in total is in a range of 0.69 to 1.02, the transmittance in two target frequency bands may be made maximum.

According to FIG. 11, the maximum value of the in-band minimum transmittance is the highest when the parameter of the outer dielectric layer in FIG. 10(a) is 0.25 and the sum of the parameters of all the three layers in FIG. 10(b) is 1.02. In the case above, the thicknesses of the respective dielectric layers are expressed as (d₁, d₂, d₃)=(1.42 mm, 1.16 mm, 1.42 mm), and the relative permittivity thereof is expressed as (ε₁, ε₂, ε₃)=(2.90, 16.1, 2.90). That is, also in the third configuration example, the relative permittivity of an inner dielectric layer is higher than the relative permittivity of outer dielectric layers, and the thickness of the inner dielectric layer is smaller than the thicknesses of the outer dielectric layers.

In FIG. 11, as for the frequency characteristics (solid line LN30), the transmittance is 1 (that is, 0 dB) at each of the center frequencies, and −0.059 dB is achieved as the minimum transmittance in a predetermined frequency band. Further, with respect to the angle characteristics, in both cases that an electric field of an incident wave is perpendicular (solid lines LN31 and LN33) and an electric field of an incident wave is horizontal (broken lines LN32 and LN34), the transmittance of −1.5 dB or more is achieved up to a range that the incident angle θ₀ is 60° or more.

As described above, a dual-band antenna protection structure having a thickness different from that of the second configuration example may also achieve high transmittance while suppressing a thickness of the entire protection structure with the configuration as follows. As same as the second configuration example, the relative permittivity of the inner dielectric layer is made higher than the relative permittivity of outer dielectric layers, the thickness of the inner dielectric layer is made smaller than the thicknesses of the outer dielectric layers, and the parameters are set within the predetermined ranges indicated in FIG. 10.

(Manufacturing Process)

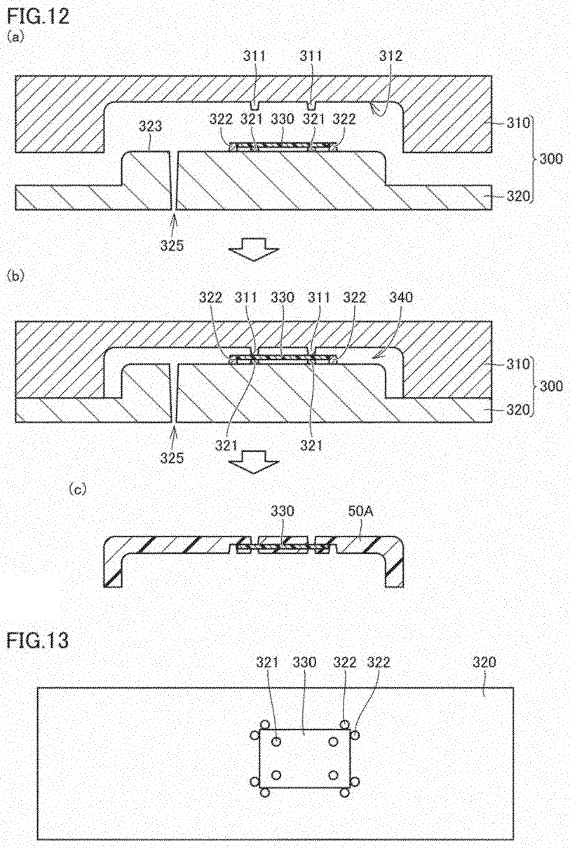

With reference to FIG. 12, an example of a manufacturing process of the three-layer antenna protection structure as described above will be explained. The protection structure may be formed by injection molding in which a resin is injected into a mold, for example.

According to FIG. 12, first, the process of FIG. 12(a) is a process of preparing a mold 300 including a first mold (upper mold) 310 and a second mold (lower mold) 320. A recessed portion 312 is formed in the upper mold 310, and a protruding portion 323 is formed in the lower mold 320. A plurality of protrusions 311 are formed in the recessed portion 312 of the upper mold 310. Further, protrusions 321 are also formed on the protruding portion 323 of the lower mold 320 at positions facing the protrusions 311 of the upper mold 310. Moreover, on the lower mold 320, protrusions 322 are formed around a region where a ceramic 330 is disposed, as illustrated in a plan view of FIG. 13.

In the process of FIG. 12(a), the flat plate-shaped ceramic 330 is disposed on the protrusions 321 of the lower mold 320. The protrusions 321 enable the ceramic 330 to be disposed at a position separated from the protruding portion 323 of the lower mold 320. The protrusions 322 are a positioning pin to place the ceramic 330 at a predetermined position, and the ceramic 330 may be disposed in a predetermined region by disposing the ceramic 330 along the protrusions 322.

When the ceramic 330 is disposed on the lower mold 320, the upper mold 310 and the lower mold 320 are brought into close contact with each other in the process of FIG. 12(b). At this time, a space 340 is formed between the recessed portion 312 of the upper mold 310 and the protruding portion 323 of the lower mold 320. Further, the ceramic 330 is supported by the protrusions 311 of the upper mold 310. Thus, the ceramic 330 is disposed at a position separated from the bottom surface of the recessed portion 312 of the upper mold 310.

In the state above, a resin is injected into the space 340 formed between the upper mold 310 and the lower mold 320 through a cavity 325 formed in the lower mold 320. At this time, since the protrusions 311 and 321 are present, the resin is also injected into the gap between the ceramic 330 and the upper mold 310 and the gap between the ceramic 330 and the lower mold 320. Thus, a three-layer structure is formed having a first resin layer between the lower mold 320 and the ceramic 330, a ceramic layer, and a second resin layer between the upper mold 310 and the ceramic 330.

Then, in the process of FIG. 12(c), a protection structure 50A is formed by removing the mold 300 after the injected resin is solidified.

At this time, the formed protection structure 50A may be made capable of achieving the characteristics described in each configuration example of Embodiment 1 with the configuration as follows. A material with higher permittivity than the relative permittivity of a resin is used as the ceramic 330, and further, each of the protruding amount of the protrusions 311 and 321 is made larger than the thickness of the ceramic 330, so that the thickness of the ceramic 330 is smaller than the thicknesses of the first resin layer and the second resin layer.

### Embodiment 2

In Embodiment 1, a configuration has been described in which a housing itself of a communication device forms a protection structure having three dielectric layers. In Embodiment 2, a configuration will be described in which a three-layer protection structure is formed by molding between a housing and an antenna module with a resin.

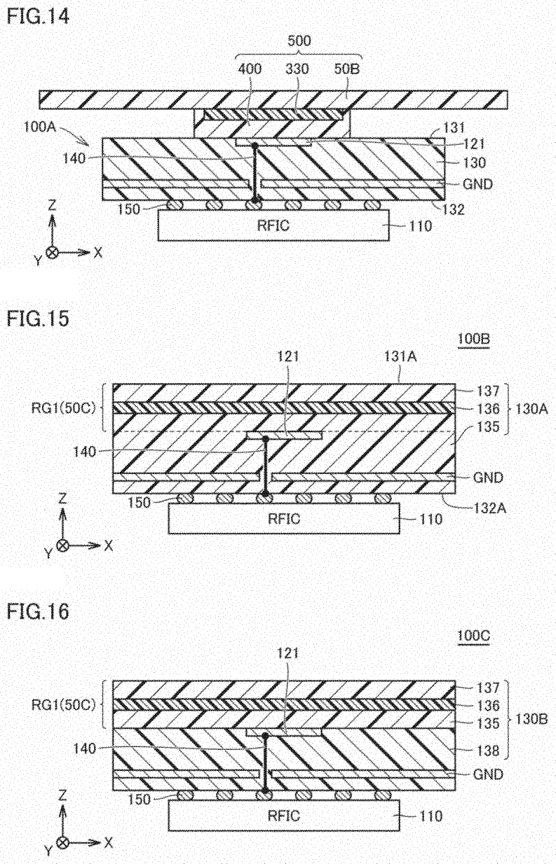

FIG. 14 is a partial sectional view of a communication device to which a protection structure 500 according to Embodiment 2 is applied. According to FIG. 14, in an antenna module 100A, a feed element 121 is disposed on an upper surface 131 of a dielectric substrate 130. A ground electrode GND is disposed in the dielectric substrate 130 on a side of a back surface 132 to face the feed element 121, and a radio frequency signal from an RFIC 110 is transferred to the feed element 121 by a feed line 140.

A housing 50B is formed of a single-layer dielectric. A ceramic 330 is disposed on an inner wall of the housing 50B, and a space between the antenna module 100A and the housing 50B is molded using a resin 400 such that the feed element 121 faces the ceramic 330. With this, the protection structure 500 having a three-layer structure is formed by the housing 50B, the ceramic 330, and the resin 400.

At this time, a protection structure having characteristics similar to those of Embodiment 1 may be achieved by making relative permittivity of the ceramic 330 as the inner layer of the three-layer structure higher than relative permittivity of the housing 50B and relative permittivity of the resin 400 and making the thickness of the ceramic 330 smaller than the thicknesses of the housing 50B and the resin 400.

Note that, as described in Embodiment 1, the transmittance may be increased by using materials for the housing 50B and the resin 400 having the same relative permittivity and forming the housing 50B and the resin 400 to have the same thickness.

### Embodiment 3

In Embodiment 1 and Embodiment 2, the configurations have been described in which a protection structure is provided separately from an antenna module. In Embodiment 3, a configuration will be described in which the protection structure as described above is formed in an antenna module.

FIG. 15 is a sectional view of an antenna module 100B in which a protection structure 50C according to Embodiment 3 is formed. According to FIG. 15, the antenna module 100B includes a dielectric substrate 130A, a radiating element (feed element) 121, a feed line 140, a ground electrode GND, and an RFIC 110.

The dielectric substrate 130A has a three-layer structure including a first dielectric layer 135, a second dielectric layer 136 laminated or disposed on the first dielectric layer 135, and a third dielectric layer 137 laminated or disposed on the second dielectric layer 136. The feed element 121 is formed inside the first dielectric layer 135. In the first dielectric layer 135, the ground electrode GND is disposed to face the feed element 121 in a layer closer than the feed element 121 to a side of a back surface 132A of the dielectric substrate 130A.

The RFIC 110 is connected to the back surface 132A of the dielectric substrate 130A via solder bumps 150. The feed line 140 starts from the RFIC 110, penetrates through the ground electrode GND, and is connected to the feed element 121. When a radio frequency signal from the RFIC 110 is transferred to the feed element 121 by the feed line 140, a radio wave is radiated from the feed element 121.

In the dielectric substrate 130A of the antenna module 100B, a three-layer structure of the first dielectric layer 135, the second dielectric layer 136, and the third dielectric layer 137 is formed in a region RG1 in a direction to which a radio wave is radiated from the feed element 121 (that is, a direction from the feed element 121 toward a front surface 131A of the dielectric substrate 130A). Then, the region RG1 of the three-layer structure may be defined as the protection structure 50C having the similar characteristics as those of Embodiment 1 and Embodiment 2 with the configuration as follows. The relative permittivity of the second dielectric layer 136 is made higher than the relative permittivity of the first dielectric layer 135 and the relative permittivity of the third dielectric layer 137, and further, the thickness of the second dielectric layer 136 is made smaller than the thicknesses of the first dielectric layer 135 and the third dielectric layer 137.

With the configuration above, an antenna module including a protection structure with high transmittance may be realized.

(Modification 1)

FIG. 16 is a sectional view of an antenna module 100C of Modification 1. In the antenna module 100C, a dielectric substrate 130B has a configuration in which dielectric layers (a first dielectric layer 135, a second dielectric layer 136, and a third dielectric layer 137) of a three-layer structure forming a protection structure 50C are laminated or disposed on a fourth dielectric layer 138. Then, a feed element 121 is disposed between the first dielectric layer 135 and the fourth dielectric layer 138 so as to be in contact with the first dielectric layer 135. In other words, the feed element 121 is formed on the surface of the fourth dielectric layer 138, and the protection structure 50C is laminated or disposed on the feed element 121 and the fourth dielectric layer 138.

Also in the configuration above, as same as the antenna module 100B of Embodiment 3, an antenna module including a protection structure with high transmittance may be realized.

Note that, an example of the protection structure 50C may have a configuration as follows. The first dielectric layer 135 is a protection film for protecting the exposed feed element 121, the third dielectric layer 137 is a housing (resin case) of the communication device 10, and the second dielectric layer 136 with high permittivity is disposed therebetween. Further, in FIG. 16, an air layer may be provided between the second dielectric layer 136 and the third dielectric layer 137.

(Modification 2)

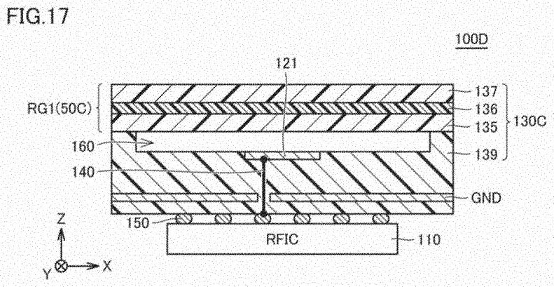

FIG. 17 is a sectional view of an antenna module 100D of Modification 2. In the antenna module 100D, a space 160 is formed below (in the negative direction of the Z-axis) a region RG1 where a protection structure 50C is formed in a dielectric substrate 130C, and a feed element 121 is formed in a dielectric layer 139 further below the space 160. In other words, the feed element 121 is disposed to face a first dielectric layer 135 of the protection structure 50C via the space 160.

In the antenna module 100D, a radio wave radiated from the feed element 121 passes through an air layer of the space 160 and dielectric layers of a three-layer structure of the protection structure 50C and is radiated to the outside of the antenna module 100D.

Also in the configuration in which a space is formed inside the dielectric substrate as in Modification 2, an antenna module including a protection structure with high transmittance may be realized by forming the protection structure as the configuration described above.

Note that the feed element 121 may be formed on the surface of the dielectric layer 139 or may be formed inside the dielectric layer 139. Further, the relative permittivity of the dielectric layer 139 may be the same as or different from that of the first dielectric layer 135.

Note that, in the antenna module 100D, a case has been described in which an air layer is formed between the first dielectric layer 135 and the feed element 121. However, instead of the air layer, a dielectric layer with the relative permittivity lower than the relative permittivity of the first dielectric layer 135 may be formed.

The “space 160 (air layer)” and the “dielectric layer with the relative permittivity lower than the relative permittivity of the first dielectric layer 135” in Modification 2 correspond to a “fifth dielectric layer” of the present disclosure.

Note that it is sufficient that, in the protection structure illustrated in each of the embodiments described above, the radiating element is included within a range of the protection structure when the antenna module is viewed in plan view. That is, the size of the protection structure in plan view of the antenna module may be larger than or equal to the size of the radiating element.

Further, the protection structure is not limited to a flat shape as illustrated in each of the embodiments described above and may have a shape in which a curved surface is partially formed. For example, a portion of a protection structure overlapping a feed element, in plan view of the protection structure from a normal direction (Z-axis direction in the drawing), may be formed in a dome shape that protrudes in the positive direction or the negative direction of the Z-axis direction.

It should be understood that the embodiments disclosed herein are illustrative and non-restrictive in all respects. It is intended that the scope of the present disclosure be indicated by the appended claims rather than the foregoing description of the embodiments and that all changes within the meaning and range of equivalency of the appended claims shall be embraced therein.

### REFERENCE SIGNS LIST

10 COMMUNICATION DEVICE
50, 50A, 50C, 500 PROTECTION STRUCTURE
50B HOUSING
51 to 53 DIELECTRIC LAYER
100, 100A to 100D ANTENNA MODULE
110 RFIC
111A to 111D, 113A to 113D, 117 SWITCH
112AR to 112DR LOW-NOISE AMPLIFIER
112AT TO 112DT POWER AMPLIFIER
114A TO 114D ATTENUATOR
115A to 115D PHASE SHIFTER
116 MULTIPLEXER/DEMULTIPLEXER
118 MIXER
119 AMPLIFIER
120 ANTENNA UNIT
121 FEED ELEMENT
122 PARASITIC ELEMENT
130, 130A DIELECTRIC SUBSTRATE
140 FEED LINE
150 SOLDER BUMP
160 SPACE
200 BBIC
300, 310, 320 MOLD
311, 321, 322 PROTRUSION
312 RECESSED PORTION
323 PROTRUDING PORTION
325 CAVITY
330 CERAMIC
340 SPACE
400 RESIN
GND GROUND ELECTRODE
SP1 FEED POINT

1. An antenna protection structure, comprising:
a first dielectric layer;
a second dielectric layer disposed on the first dielectric layer; and
a third dielectric layer disposed on the second dielectric layer,
wherein a relative permittivity of the second dielectric layer is higher than a relative permittivity of the first dielectric layer, and the relative permittivity of the second dielectric layer is higher than a relative permittivity of the third dielectric layer, and
a thickness of the second dielectric layer is smaller than a thickness of the first dielectric layer in a first direction, and the thickness of the second dielectric layer is smaller than a thickness of the third dielectric layer in the first direction.

2. The antenna protection structure according to claim 1,
wherein the relative permittivity of the first dielectric layer is equal to the relative permittivity of the third dielectric layer.

3. The antenna protection structure according to claim 1,
wherein the thickness of the first dielectric layer is equal to the thickness of the third dielectric layer.

4. The antenna protection structure according to claim 1,
wherein, in each dielectric layer, under a condition a value obtained by dividing a thickness of the dielectric layer by an effective wavelength in the dielectric layer is defined as a first parameter,
the first parameter of each of the first dielectric layer and the third dielectric layer is greater than 0.2 and less than 0.33, and
a sum of the first parameters of the first dielectric layer, the second dielectric layer, and the third dielectric layer is greater than 0.67 and smaller than 0.90.

5. The antenna protection structure according to claim 1,
wherein, in each dielectric layer, under a condition a value obtained by dividing a thickness of the dielectric layer by an effective wavelength in the dielectric layer is defined as a first parameter,
the first parameter of each of the first dielectric layer and the third dielectric layer is greater than 0.24 and less than 0.27, and
a sum of the first parameters of the first dielectric layer, the second dielectric layer, and the third dielectric layer is greater than 0.99 and smaller than 1.02.

6. The antenna protection structure according to claim 1,
wherein the first dielectric layer and the third dielectric layer are made of a resin, and
the second dielectric layer is made of ceramic.

7. The antenna protection structure according to claim 2,
wherein the thickness of the first dielectric layer is equal to the thickness of the third dielectric layer.

8. The antenna protection structure according to claim 2,
wherein, in each dielectric layer, under a condition a value obtained by dividing a thickness of the dielectric layer by an effective wavelength in the dielectric layer is defined as a first parameter,
the first parameter of each of the first dielectric layer and the third dielectric layer is greater than 0.2 and less than 0.33, and
a sum of the first parameters of the first dielectric layer, the second dielectric layer, and the third dielectric layer is greater than 0.67 and smaller than 0.90.

9. The antenna protection structure according to claim 2,
wherein, in each dielectric layer, under a condition a value obtained by dividing a thickness of the dielectric layer by an effective wavelength in the dielectric layer is defined as a first parameter,
the first parameter of each of the first dielectric layer and the third dielectric layer is greater than 0.24 and less than 0.27, and
a sum of the first parameters of the first dielectric layer, the second dielectric layer, and the third dielectric layer is greater than 0.99 and smaller than 1.02.

10. The antenna protection structure according to claim 2,
wherein the first dielectric layer and the third dielectric layer are made of a resin, and
the second dielectric layer is made of ceramic.

11. A communication device, comprising:
a housing including the antenna protection structure according to claim 1; and
an antenna module accommodated in the housing.

12. A communication base station, comprising:
a housing including the antenna protection structure according to claim 1; and
an antenna module accommodated in the housing.

13. An antenna module, comprising:
a radiating element;
a first dielectric layer formed to face the radiating element;
a second dielectric layer disposed on the first dielectric layer; and
a third dielectric layer disposed on or above the second dielectric layer,
wherein a relative permittivity of the second dielectric layer is higher than a relative permittivity of the first dielectric layer, and the relative permittivity of the second dielectric layer is higher than a relative permittivity of the third dielectric layer, and
a thickness of the second dielectric layer is smaller than a thickness of the first dielectric layer in a first direction, and the thickness of the second dielectric layer is smaller than a thickness of the third dielectric layer in the first direction.

14. The antenna module according to claim 13,
wherein the radiating element is disposed inside the first dielectric layer.

15. The antenna module according to claim 13, further comprising:
a fourth dielectric layer,
wherein the first dielectric layer is disposed on the fourth dielectric layer, and
the radiating element is disposed between the first dielectric layer and the fourth dielectric layer so as to be in contact with the first dielectric layer.

16. The antenna module according to claim 13,
wherein a fifth dielectric layer with relative permittivity lower than the relative permittivity of the first dielectric layer is disposed between the radiating element and the first dielectric layer.

17. The antenna module according to claim 13,
wherein the relative permittivity of the first dielectric layer is equal to the relative permittivity of the third dielectric layer.

18. The antenna module according to claim 13,
wherein the thickness of the first dielectric layer is equal to the thickness of the third dielectric layer.

19. The antenna module according to claim 13,
wherein, in each dielectric layer, under a condition a value obtained by dividing a thickness of the dielectric layer by an effective wavelength in the dielectric layer is defined as a first parameter,
the first parameter of each of the first dielectric layer and the third dielectric layer is greater than 0.2 and less than 0.33, and
a sum of the first parameters of the first dielectric layer, the second dielectric layer, and the third dielectric layer is greater than 0.67 and smaller than 0.90.

20. A method for manufacturing an antenna protection structure, comprising the steps of:
preparing a resin with first relative permittivity;
preparing flat plate-shaped ceramic with second relative permittivity higher than the first relative permittivity;
preparing a first mold and a second mold;
disposing the ceramic between the first mold and the second mold at a position spaced apart from the first mold and the second mold; and
forming a member having a three-layer structure of a first resin layer, a ceramic layer, and a second resin layer by injecting the resin into a space formed between the first mold and the second mold,
wherein a thickness of the ceramic layer is smaller than a thickness of the first resin layer, and the thickness of the ceramic layer is smaller than a thickness of the second resin layer.
